(19) United States
(12) Patent Application Publication
(10) Pub. No.: US 2013/0124585 A1
(43) Pub. Date: May 16, 2013

(54) FILE PROCESSING APPARATUS AND FILE PROCESSING METHOD

(71) Applicants: Kenichiro SUZUKI, Yokohama-shi (JP); Kazuhito Shimomura, Fussa-shi (JP); Yuji Sakai, Yokohama-she (JP); Atsushi Fukushima, Akishima-shi (JP); Masaaki Inoue, Hamura-shi (JP)

(72) Inventors: Kenichiro SUZUKI, Yokohama-shi (JP); Kazuhito Shimomura, Fussa-shi (JP); Yuji Sakai, Yokohama-she (JP); Atsushi Fukushima, Akishima-shi (JP); Masaaki Inoue, Hamura-shi (JP)

(73) Assignee: Kabushiki Kaisha Toshiba, Tokyo (JP)

(21) Appl. No.: 13/612,409

(22) Filed: Sep. 12, 2012

(30) Foreign Application Priority Data
Nov. 15, 2011 (JP) 2011-250055

(51) Int. Cl. G06F 17/30

(52) U.S. Cl. 707/822; 707/E17.01

(57) ABSTRACT

According to one embodiment, a file processing apparatus includes a file group generator, a divided file generator, and a recorder. The file group generator is configured to generate a file group formed by a plurality of first processing target files each having a size less than a threshold size of processing target files. The divided file generator is configured to generate first divided files by dividing the file group, and to generate second divided files by dividing a second processing target file having a size not less than the threshold size of the processing target files. The recorder is configured to record the first and second divided files.

### CROSS-REFERENCE TO RELATED APPLICATIONS

This application is based upon and claims the benefit of priority from prior Japanese Patent Application No. 2011-250055, filed Nov. 15, 2011, the entire contents of which are incorporated herein by reference.

### FIELD

Embodiments described herein relate generally to a file processing apparatus and file processing method.

### BACKGROUND

In recent years, various file management techniques have been proposed. For example, a technique called mirroring, which “saves an identical file on a plurality of storage media”, has been proposed.

With this proposed technique, a recordable capacity decreases practically.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a schematic block diagram showing an example of the arrangement of a file processing apparatus according to the first and second embodiments;

FIG. 2 is a view showing an example of divisional recording on a plurality of (for example, n+1) parallel-connected storages according to the first embodiment;

FIG. 3 is a view showing an example of eight files as processing targets according to the first embodiment;

FIG. 4 is a view showing a first example of divisional recording for explaining effects of the divisional recording according to the first embodiment;

FIG. 5 is a view showing a second example of divisional recording for explaining effects of the divisional recording according to the first embodiment;

FIG. 6 is a view showing an example of a less-than-threshold file group and a not-less-than-threshold file according to the first embodiment;

FIG. 7 is a view showing an example of dividing processing for dividing the less-than-threshold file group into a plurality of files, and dividing the not-less-than-threshold file into a plurality of files according to the first embodiment;

FIG. 8 is a view showing an example of generation of file images according to the first embodiment;

FIG. 9 is a view showing an example of file headers and error detection/correction data according to the first embodiment;

FIG. 10 is a view showing an example of re-generation of file images according to the first embodiment;

FIG. 11 is a view showing an example of divisional recording in a plurality of (4+1) parallel-connected storages according to the first embodiment; and

FIG. 12 is a view showing an example of a file processing apparatus and reproduction apparatus which implement restoration and reproduction processes according to the second embodiment.

### DETAILED DESCRIPTION

The first and second embodiments will be described hereinafter with reference to the accompanying drawings. Common items of the first and second embodiments will be described first.

In general, according to one embodiment, a file processing apparatus includes a file group generator, a divided file generator, and a recorder. The file group generator is configured to generate a file group formed by a plurality of first processing target files each having a size less than a threshold size of processing target files. The divided file generator is configured to generate first divided files by dividing the file group, and to generate second divided files by dividing a second processing target file having a size not less than the threshold size of the processing target files. The recorder is configured to record the first and second divided files.

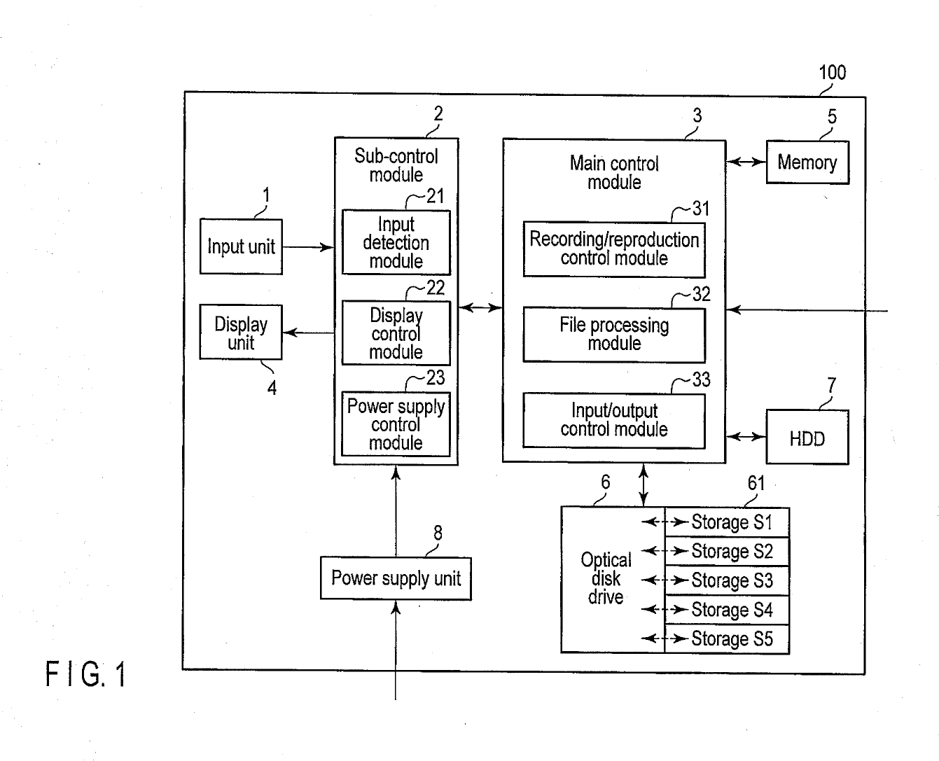

FIG. 1 is a schematic block diagram showing the arrangement of a file processing apparatus according to the first and second embodiments. A file processing apparatus 100 can parallelly record (simultaneously record) a plurality of files on a plurality of data storage media (a plurality of recording destinations). Alternatively, the file processing apparatus 100 can record (sequentially record) a plurality of files on a plurality of data storage media while exchanging data storage media one by one or by the predetermined number of media. In this case, the file processing apparatus 100 is compatible to a changer, which automatically exchanges data storage media.

Furthermore, the file processing apparatus 100 can parallelly read (simultaneously read) a plurality of files from a plurality of storage media, and can reproduce data based on the plurality of read files. Alternatively, the file processing apparatus 100 can read (sequentially read) a plurality of files from a plurality of storage media and can reproduce data based on the plurality of read files while exchanging the data storage media one by one or by the predetermined number of media. In this case, the file processing apparatus 100 is compatible to a changer, which automatically exchanges data storage media.

As a data storage medium, various media such as an optical disc, magnetic disk, and flash memory are applicable. The first and second embodiments to be described hereinafter will mainly explain a case in which optical discs are applied as data storage media, but the first and second embodiments are not limited to processing of optical discs.

As shown in FIG. 1, the file processing apparatus 100 includes an input unit 1, sub-control module 2, main control module 3, display unit 4, memory 5, optical disc drive 6, hard disk drive (HDD) 7, and power supply unit 8.

The sub-control module 2 includes an input detection module 21, display control module 22, and power supply control module 23. The main control module 3 includes a recording/reproduction processing module 31, file processing module 32, and input/output control module 33. The main control module 3 transmits display data to be displayed by the display unit 4 to the display control module 22. The display control module 22 controls the display unit 4 based on the display data. Then, the display unit 4 can display display information corresponding to the display data.

For example, the input unit 1 includes a power key, record key, play key, and the like. The user can control the operations of the file processing apparatus 100 by making input operations to the input unit 1.

The power key is used to instruct to turn on/off a power supply of the file processing apparatus 100. Upon pressing of the power key, the input detection module 21 of the sub-control module 2 detects pressing of the power key, and the power supply control module 23 of the sub-control module 2 notifies the power supply unit 8 of switching power on or off. The power supply unit 8 turns on the power supply in a power-off state, or turns off the power supply in a power-on state.

The optical disc drive 6 includes, for example, a plurality of optical disc drives, can record data on one or a plurality of optical discs, and can read data recorded on one or a plurality of optical discs. In the first and second embodiments, for example, recording/reproduction processing for a plurality of optical discs stored in a magazine 61 will be explained. For example the magazine 61 stores a plurality of optical discs (storages S1 to S5).

The input/output control module 33 receives one or a plurality of externally provided files, and outputs them to, for example, the HDD 7. Then, the HDD 7 can record one or a plurality of externally provided files on a hard disk. The input/output control unit 33 can receive one or a plurality of externally provided files, and can also output them to the optical disc drive 6. Then, the optical disc drive 6 can record one or a plurality of externally provided files on one or a plurality of storages. Furthermore, the input/output control module 33 can receive one or a plurality of files recorded on the hard disk, and can output them to the optical disc drive 6. Then, the optical disc drive 6 can record one or a plurality of files recorded on the hard disk on one or a plurality of storages.

The first and second embodiments will be described in turn. In the first embodiment, divisional recording of files will be explained. In the second embodiment, restoration/reproduction processing of divisionally recorded files will be explained.

### First Embodiment

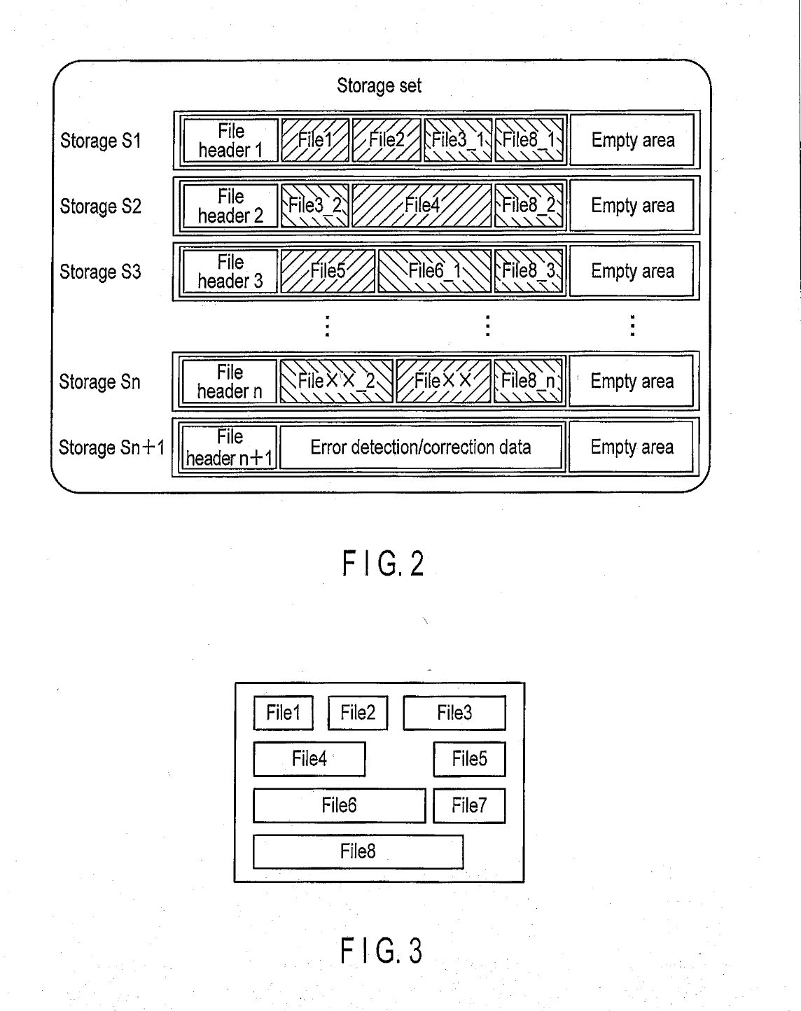

FIG. 2 is a view showing a data recording example on a plurality of (for example, n+1) parallel-connected storages according to the first embodiment.

“File N” is a file which is not divided (non-divided file), and “file N_M” indicates an M-th file of a plurality of divided files generated by dividing the file N into a plurality of files. Divisional recording will be explained below assuming five parallel-connected optical discs (storages S1 to S5) and eight files (files 1 to 8 shown in FIG. 3) as processing targets.

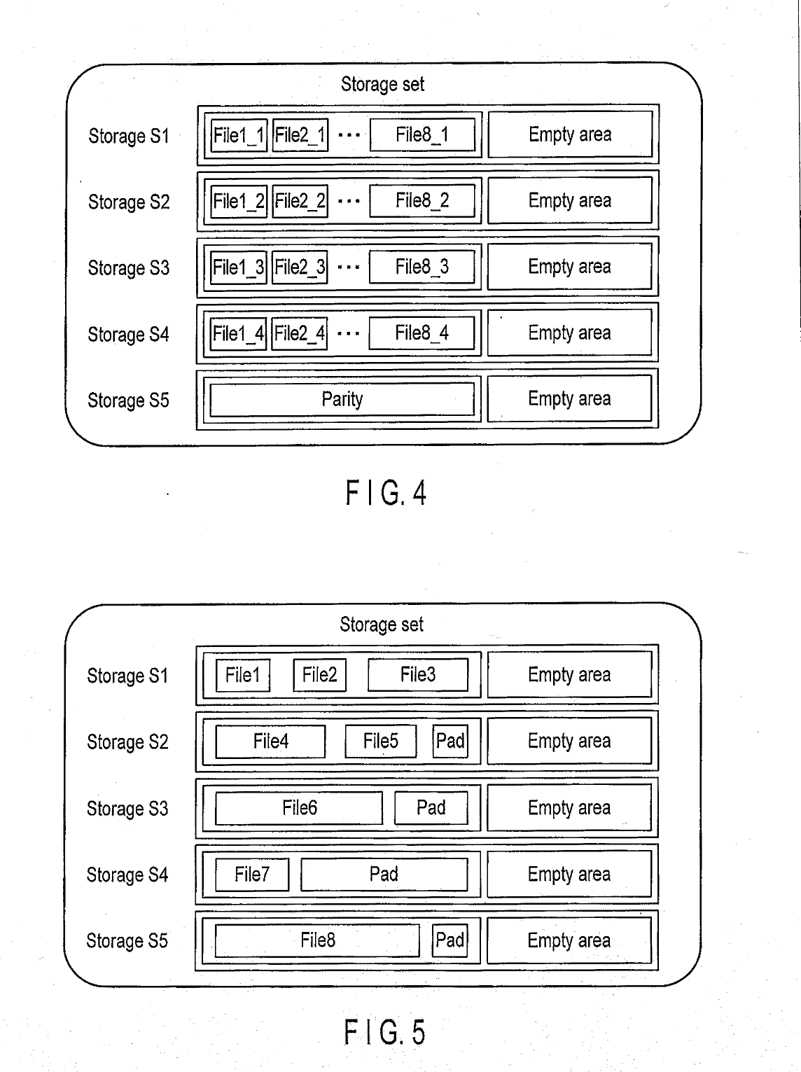

Upon execution of parallel recording of processing target files in a RAID function used in a hard disk, a recording method which combines file data and parity data, as shown in FIG. 4, is used. Using such recording method, parallel recording/reproduction processes of files can be executed for a plurality of storages, and the recording/reproduction speed can be improved according to the number of parallelly arranged drives. Also, using the parity data, files can be restored even when problems have occurred in some storages.

In the above recording method, all storages are required to reproduce files, and none of files can be reproduced from one storages. Even when some of all the storages have been damaged or lost due to occurrence of a disaster, it is demanded to restore files as much as possible from the surviving storages. Especially, such demand is increasing in technical fields of archive apparatuses using optical discs. It is not easy for the recording method shown in FIG. 4 to meet the above demand. A generally known archive apparatus recognizes a plurality of parallel-connected storages as one storage device, and executes recording/reproduction processes. For example, the archive apparatus parallelly records a plurality of files on a plurality of parallel-connected storages together, and reproduces a plurality of files from a plurality of storages together.

For example, as shown in FIG. 5, a recording method which records data without dividing them has been proposed. According to this recording method, the aforementioned demand can be met. In parallel recording processing using a plurality of devices, a method of setting uniform data sizes to be recorded by the plurality of devices so as to eliminate outer/inner recording/reproduction speed differences is adopted. However, in this case, in the recording method shown in FIG. 5, many extra areas (“pad” shown in FIG. 5) to be added to positions before and after data have to be prepared, thus wasting a recording capacity.

Also, although a plurality of devices are parallelly connected, a time required to record/reproduce one file is unwantedly equal to that required to record/reproduce one file by a single device.

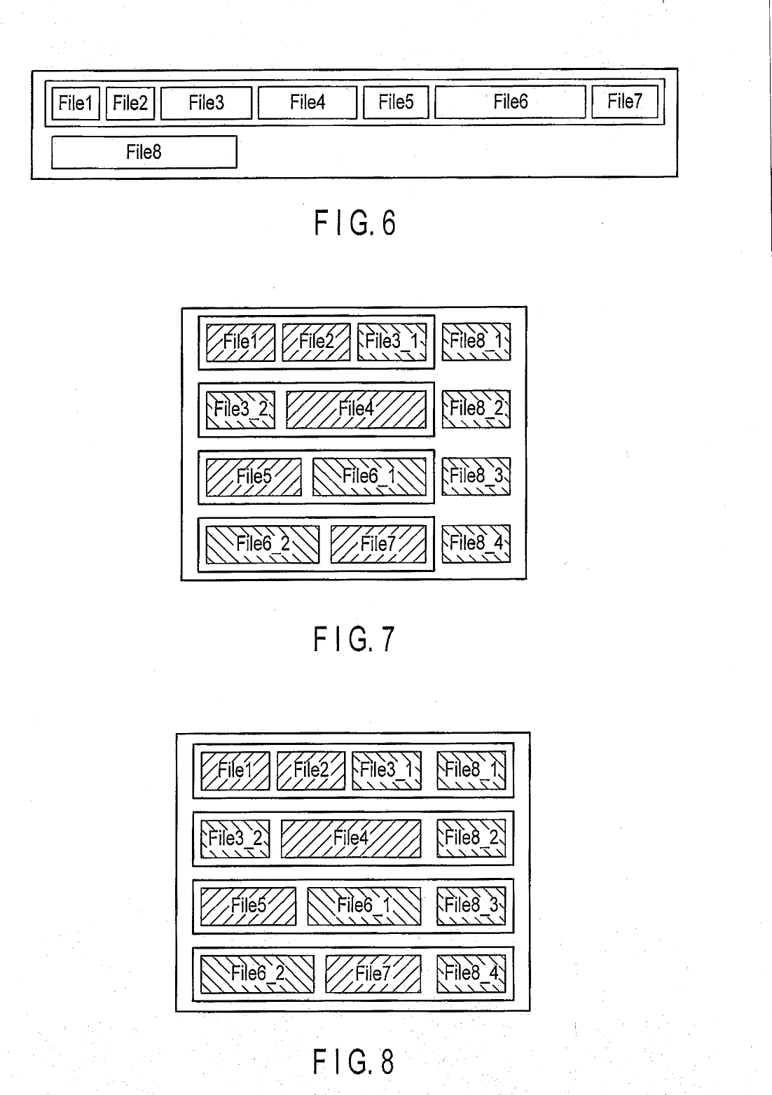

According to divisional recording to be described with reference to FIGS. 6, 7, 8, 9, 10, and 11, files can be efficiently and effectively recorded.

A minimum file size of a file for which a recording/reproduction time is to be shortened in the parallel processing will be referred to as “threshold” hereinafter. For example, the file management module 32 manages the threshold, and changes the threshold in accordance with an instruction from the user (an input from the input unit 1). Assume that of eight files (files 1 to 8) as processing targets shown in FIG. 3, for example, files 1 to 7 have file sizes less than the threshold, and file 8 has a file size not less than the threshold. Files 1 to 7 having the file sizes less than the threshold will be defined as first processing target files hereinafter, and file 8 having the file size not less than the threshold will be defined as a second processing target file hereinafter.

The file processing module 32 detects eight file sizes as processing targets, and classifies each of these eight files into a first or second processing target file. That is, as shown in FIG. 6, the file processing module 32 classifies these eight files into files 1 to 7 and file 8. A group of the files having the file sizes less than the threshold will be referred to as “less-than-threshold file group” or simply as “file group” hereinafter (an upper file group in FIG. 6).

The file processing module 32 divides the less-than-threshold file group and the file having the file size not less than the threshold into files, the number of which is equal to or smaller than the number of parallel-connected optical discs. For example, the file processing module 32 divides the less-than-threshold file group into four equal sizes and also the file having the file size not less than the threshold into four equal sizes using parallel-connected storages S1 to S5 as recording destinations (see FIG. 7). Note that the equal size divisions are not perfect equal size divisions and generate differences of about several bytes in practices. With these divisions, “Pad” areas described above with reference to FIG. 5 can be reduced to sufficiently small sizes. That is, each “Pad” area can be reduced to a size required to fill the difference.

As described above, the file processing module 32 divides the less-than-threshold file group into four equal sizes to generate four divided files. Each of these four divided files will be defined as a first divided file hereinafter. The file processing module 32 also divides the file having the file size not less than the threshold into four equal sizes to generate four divided files. Each of these four divided files will be defined as a second divided file hereinafter.

As shown in FIG. 7, files 1, 2, and 3_1 form a first divided file. Also, files 3_2 and 4 form a first divided file. Files 5 and 6_1 form a first divided file. Files 6_2 and 7 form a first divided file. Furthermore, each of files 8_1, 8_2, 8_3, and 8_4 is a second divided file.

Furthermore, the file management module 32 combines one first divided file and one second divided file to form four combined files. Each combined file will be referred to as “file image” hereinafter (see FIG. 8). Note that each combined file will also be referred to as “file format”. A first file image (first file format) includes files 1, 2, 3_1, and 8_1. A second file image (second file format) includes files 3_2, 4, and 8_2. A third file image (third file format) includes files 5, 6_1, and 8_3. A fourth file image (fourth file format) includes files 6_2, 7, and 8_4.

The recording/reproduction control module 31, controls to parallelly record these first to fourth file images on storages S1 to S4. In response to this, the optical disc drive 6 parallelly records these first to fourth file images on storages S1 to S4.

The recording/reproduction control module 31 controls to parallelly read files from storages S1 to S4. In response to this, the optical disc drive 6 parallelly reads the first to fourth file images from storages S1 to S4.

With the aforementioned control, the file having the file size not less than the threshOld can undergo high-speed recording/reproduction. Also, each of files having the file sizes less than the threshold can be restored and reproduced even when problems have occurred in other optical discs which do not include that file unless problems occur in one or a plurality of optical discs which include that file or a part of that file.

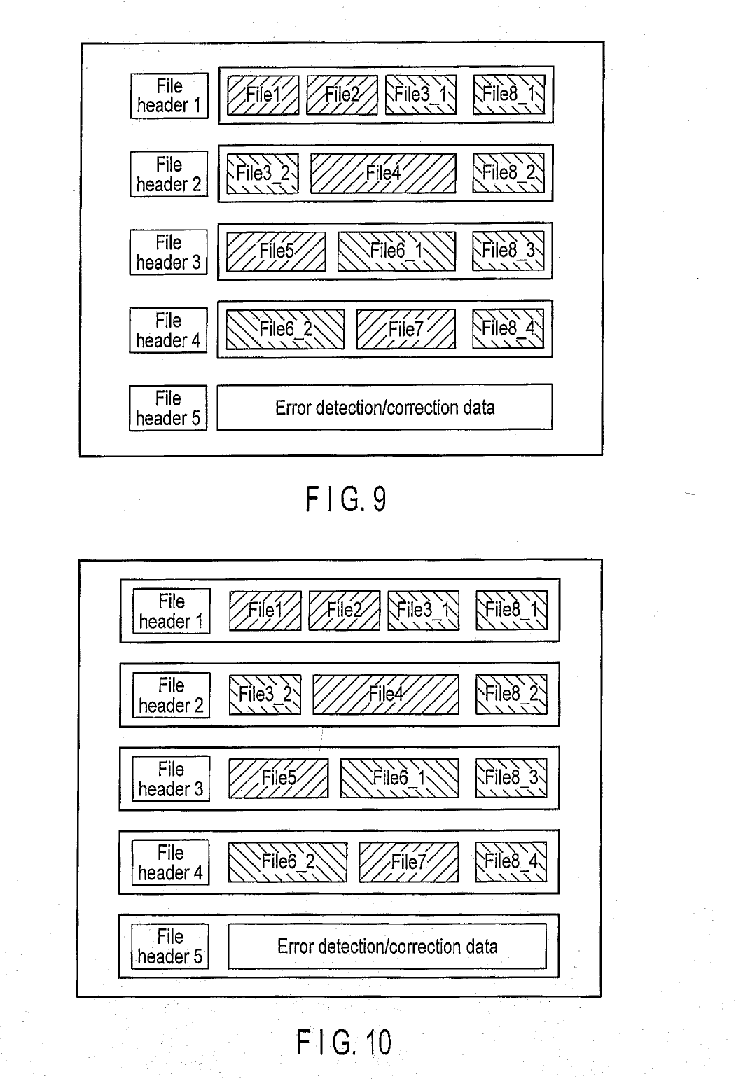

The file processing module 32 generates data such as parity data or hash data from all the file images (see FIG. 9). The data such as parity data or hash data is used to detect and correct errors when problems (errors) have occurred in any of file image data. The data such as parity data or hash data will be referred to as “error detection/correction data” hereinafter.

Furthermore, the file processing module 32 generates file information and storage configuration information indicating recording locations of respective processing target files (files 1 to 8), and generates data such as parity data or hash data from each of the file images. Data such as parity data or hash data generated from the first file image (files 1, 2, 3_1, and 8_1) is used to detect and correct errors when problems (errors) have occurred in the first file image. The file processing module 32 combines the file information and storage configuration information with the data such as parity data or hash data generated from the first file image to generate file header 1 for the first file image. Likewise, the file processing module 32 combines the file information and storage configuration information with data such as parity data or hash data generated from the second file image (files 3_2, 4, and 8_2) to generate file header 2 for the second file image. Also, the file processing module 32 combines the file information and storage configuration information with data such as parity data or hash data generated from the third file image (files 5, 6_1, and 8_3) to generate file header 3 for the third file image. Furthermore, the file processing module 32 combines the file information and storage configuration information with data such as parity data or hash data generated from the fourth file image (files 6_2, 7, and 8_4) to generate file header 4 for the fourth file image.

The file processing module 32 re-forms a new first file image (new first file format) including file header 1 and the first file image. Likewise, the file processing module 32 re-forms a new second file image (new second file format) including file header 2 and the second file image. Also, the file processing module 32 re-forms a new third file image (new third file format) including file header 3 and the third file image. Furthermore the file processing module 32 re-forms a new fourth file image (new fourth file format) including file header 4 and the fourth file image.

The file processing module 32 generates data such as parity data or hash data also from the error detection/correction data. The data such as parity data or hash data generated from the error detection/correction data is used to detect and correct errors when problems (errors) have occurred in the error detection/correction data. The file processing module 32 generates file header 5 for the error detection/correction data by combining the aforementioned file information and storage configuration information, and the data such as parity data or hash data generated from the error detection/correction data.

The file processing module 32 forms a fifth file image including file header 5 and the error detection/correction data.

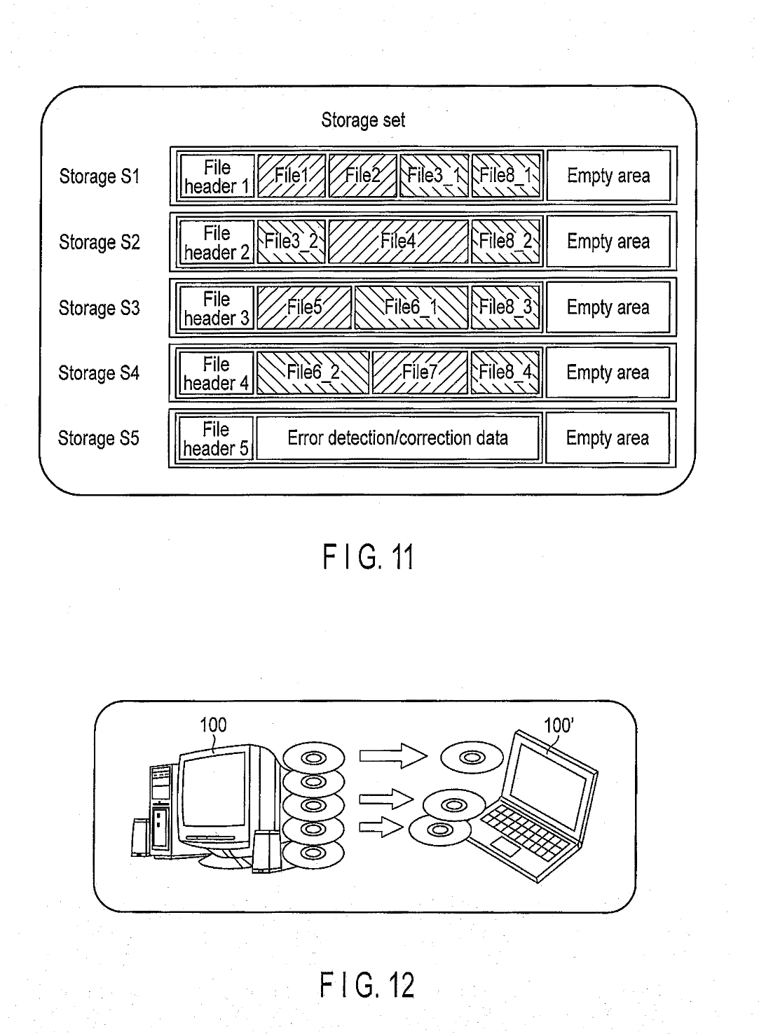

The recording/reproduction control module 31 controls to parallelly record the re-formed first to fourth file images and the formed fifth file image on storages S1 to S5. In response to this, the optical disc drive 6 parallelly records these first to fifth file images on storages S1 to S5 (see FIGS. 10 and 11). Then, even when problems have occurred in data recorded in the storages, the problems can be detected or corrected.

With the aforementioned processes, the file processing apparatus 100 shown in FIG. 1 can record the file images on the respective storages, as shown in FIG. 2.

The divisional recording implementation method by the file processing apparatus 100 shown in FIG. 1 will be further described below. For example, the input/output control module 33 reads the eight files (files 1 to 8) as processing targets from the hard disk, and the file processing module 32 detects file sizes of these eight files. Furthermore, the file processing module 32 generates a file group including a plurality of first processing target files (files 1 to 7) less than the threshold size of the eight files, and divides the file group (files 1 to 7) into a plurality of files to generate a plurality of first divided files. The file processing module 32 divides a second processing target file (file 8) not less than the threshold size of the eight files into a plurality of files to generate a plurality of second divided files.

For example, when the processing target files (files 1 to 8) are recorded on the four storages S1 to S4, the file processing module 32 divides the file group (files 1 to 7) into four files to generate four first divided files, and also divides the second processing target file (file 8) into four files to generate four second divided files. In other words, the file processing module 32 divides the file group into four files having substantially the same sizes (for example, it divides the file group into four files each of a first size or smaller), and also divides the second processing target file into four files having substantially the same sizes (for example, it divides that target file into four files each of a second size or smaller).

Note that the first size is a ¼ the file size of the file group, and the second size is a ¼ the file size of the second processing target file. For example, even when the file group is to be divided into four files each of size 250 MB, it may be unwantedly divided into files each of a size smaller than 250 MB depending on the file size of the file group and various conditions. Therefore, as described above, the file processing module 32 divides the file group into four files each having the first size or smaller.

Likewise, even when the second processing target file is to be divided into four files each of size 50 MB, it may be unwantedly divided into files each of a size smaller than 50 MB. Therefore, as described above, the file processing module 32 divides the second processing target file into four files each of the second size or smaller.

The recording/reproduction control module 31 controls to record a plurality of combined files each of which is obtained by combining one first divided file and one second divided file on the plurality of optical discs. In response to this, the optical disc drive 6 records (parallelly records) the plurality of combined files on the plurality of optical discs, respectively.

That is, the optical disc drive 6 records the first file image (files 1, 2, 3_1, and 8_1) on storage S1, the second file image (files 3_2, 4, and 8_2) on storage S2, the third file image (files 5, 6_1, and 8_3) on storage S3, and the fourth file image (files 6_2, 7, and 8_4) on storage S4.

Also, as described above, the file management module 32 generates management information (file headers) indicating that the plurality of combined files are recorded on the plurality of optical discs, and the recording/reproduction control module 31 controls to record the management information on the respective optical discs. In response to this, the optical disc drive 6 records (parallelly records) the management information on the respective optical discs.

For example, the management information includes information (media ID, addresses, lengths, etc.) indicating recording locations of files 1, 2, 3_1, and 8_1 which form the first file image on storage S1, that (media ID, addresses, lengths, etc.) indicating recording locations of files 3_2, 4, and 8_2 which form the second file image on storage S2, that (media ID, addresses, lengths, etc.) indicating recording locations of files 5, 6_1, and 8_3 which form the third file image on storage S3, and that (media ID, addresses, lengths, etc.) indicating recording locations of files 6_2, 7, and 8_4 which form the fourth file image on storage S4.

Note that as described above, for example, the file processing module 32 re-forms a new first file image from the first file image and management information, a new second file image from the second file image and management information, a new third file image from the third file image and management information, and a new fourth file image from the fourth file image and management information. Then, the optical disc drive 6 records the re-formed new first to fourth file images on storages S1 to S4.

Furthermore, as described above, for example, the file processing module 32 generates data such as parity data or hash data from the first to fourth file images, and the optical disc drive 6 records the generated data such as parity data or hash data on storage S5. Also; the optical disc drive 6 can also record data such as parity data or hash data on storage S5 together with the aforementioned management information.

The first embodiment will be summarized below.

(1) The file processing apparatus 100 combines a plurality of files which meet a predetermined condition based on sizes of files as recording/reproduction targets (processing targets) to generate a file group, divides the file group to generate a plurality of divided files, and parallelly records the plurality of divided files on a plurality of storages. Also, the file processing apparatus 100 reproduces the plurality of divided files from the plurality of storages. Thus, the recording and reproduction processes can be speeded up.

(2) The file processing apparatus 100 changes the division method depending on file sizes. For example, the file processing apparatus 100 combines a plurality of files having sizes less than a threshold to generate a file group, and divides the file group into the predetermined number of files having substantially equal sizes to generate a plurality of first divided files. Also, the file processing apparatus 100 divides a file having a size not less than the threshold into the predetermined number of files having substantially equal sizes to generate a plurality of second divided files. The file processing apparatus 100 records a plurality of combined files obtained by combining the first divided files and second divided files on a plurality of storages. Also, the file processing apparatus 100 reproduces the plurality of combined files from the plurality of storages. Note that the file processing apparatus 100 accepts a change instruction of the threshold.

In this way, the recording and reproduction processes can be speeded up. Also, extra areas (padding areas) added before and after recorded data can be reduced. Each of the files (files 1, 2, 4, 5, and 7), which are recorded without being divided practically, can be reproduced from one storage. For example, the file processing apparatus 100 can reproduce files 1 and 2 from storage S1 even when storages S2 to S5 are not available. Furthermore, even files (files 3 and 6) which are divided practically can be reproduced from a plurality of some storages even when not all of the storages are available. For example, the file processing apparatus 100 can restore and reproduce file 3 from storages S1 and S2, and can restore and reproduce file 6 from storages S4 and S5.

As described above, according to the first embodiment, the file processing apparatus 100 focuses attention on file sizes of the processing target files, and selects file division methods. As described above, the file processing apparatus 100 equally divides a file having a file size not less than the threshold into a plurality of files, and parallelly writes or reads them in or from the parallel-connected storage media. For this reason, the recording speed can be improved. Also, the file processing apparatus 100 combines a plurality of files each having a size less than the threshold to generate a file group, equally divides the file group into a plurality of files, and parallelly writes or reads them in or from the parallel-connected storage media. For this reason, the recording speed can be improved, and extra areas added before and after recorded data can be reduced to sufficiently small sizes.

Furthermore, the file processing apparatus 100 also has an error detection/correction function. That is, as described above, the file processing apparatus 100 generates error detection/correction data for the first to fourth file images, records the first to fourth file images on storages S1 to S4, and records the error detection/correction data on storage S5. The file processing apparatus 100 reads data on storages S1 to S5, and when problems (errors) have occurred in some of the first to fourth file images, it can detect and correct errors based on the error detection/correction data.

As described above, the file processing apparatus 100 can reproduce files as much as possible from one storage by executing the divisional recording.

### Second Embodiment

A generally known archive apparatus recognizes a plurality of parallel-connected storages as one storage device, and executes recording and reproduction processes. For this reason, when a disaster or the like has occurred, and some storages (one or two or more storages) of the plurality of parallel-connected storages have been damaged, dispersed, or lost, it is difficult to reproduce files from the surviving storages (one or two or more storages).

It is demanded to restore data as much as possible from the surviving storages. The demand is increasing in the technical fields of archive apparatuses. As described in the first embodiment, the file processing apparatus 100 records a plurality of divided files on a plurality of storages, and records headers on the respective storages. Each header includes information indicating a storage and recording locations of data (divided files). The file processing apparatus 100 reads the headers from some storages (one or two or more storages) and analyzes the headers, thereby restoring and reproducing files as much as possible from the some storages.

Restoration and reproduction processes of divisionally recorded files described in the second embodiment can be implemented by the file processing apparatus 100 which executed the divisional recording, or by various reproduction apparatuses 100′ (general-purpose computers) other than the file processing apparatus 100 (see FIG. 12).

When some storages (for example, two or more storages) are connected to the file processing apparatus 100 or reproduction apparatus 100′ so as to restore divisionally recorded files, these storages may be parallelly connected together or may be connected one by one. The connection order of some storages to the file processing apparatus 100 or reproduction apparatus 100′ is not limited, and any of the storages may be connected first.

The restoration and reproduction processes of the divisionally recorded files will be described below with reference to FIG. 2. A group of a plurality of files as one file will be defined as “file group” hereinafter. File images and file headers are as described in the first embodiment.

The second embodiment will explain file restoration and reproduction processes premised on the divisional recording described in the first embodiment. That is, a case will be assumed wherein files (files 1, 2, 4, 5, and 7) which are recorded without being divided practically and files (files 3 and 6) which are divided practically are recorded together on storages S1 to S4, as shown in FIG. 11. Also, a case will be assumed wherein error detection/correction data such as parity data or hash data is recorded on storage S5. Furthermore, a case will be assumed wherein file headers 1 to 5 are recorded on storages S1 to S5.

File headers 1 to 5 include the following pieces of information:

(1) information of files recorded in all the storages (boundary information (addresses, lengths) of all the files recorded on storages S1 to S5 and error detection/correction data);

(2) information of all the storages (information indicating that storages S1 to 55 form one storage set, the divided files are recorded on storages S1 to S4, and the error detection/correction data is recorded on storage S5);

(3) information of all the files (the number of, target files and attribute information of the respective files); and

(4) information of the divided files (information indicating the numbers of divided files of each file and ordinal numbers of divided files included in respective file images).

The file processing apparatus 100 can restore and reproduce data as much as possible even from some storages with reference to the file headers.

For example, a case will be described below wherein the file processing apparatus 100 connects the storages in the order of storages S4, S3, S1, and S5, and executes processing.

(1) Connection of Storage S4

The recording/reproduction control module 31 of the file processing apparatus 100 reads the fourth file image from the storage S4. The file processing module 32 acquires file header 4 from the fourth file image, analyzes file header 4, and determines that file 7 is a non-divided file which is stored without being divided. Then, the file processing module 32 can restore and reproduce file 7 from the fourth file image.

Also, the file processing module 32 analyzes file header 4 to detect that file 6 is divided into two files, file 8 is divided into four files, and the storage S4 stores file 6_2 (second file of file 6) and file 8_4 (fourth file of file 8).

When the file processing apparatus 100 processes only the storage S4, as described above, it can restore and reproduce file 7. Furthermore, the file processing apparatus 100 may restore and reproduce files 6 and 8 by processing other storages.

(2) Connection of Storage S3

The recording/reproduction control module 31 of the file processing apparatus 100 reads the third file image from the storage S3. The file processing module 32 acquires file header 3 from the third file image, analyzes file header 3, and determines that file 5 is a non-divided file which is stored without being divided. Thus, the file processing module 32 can restore and reproduce file 5 from the third file image.

Also, the file processing module 32 analyzes file header 3 and detects that file 6 is divided into two files, file 8 is divided into four files, and the storage S3 stores file 6_1 (first file of file 6) and file 8_3 (third file of file 8).

The file processing module 32 merges file 6_2 included in the already read fourth file image with file 6_1 included in the currently read third file image, and can restore and reproduce file 6.

As described above, when the file processing apparatus 100 processes the storages S4 and S3, it can restore and reproduce files 5, 6, and 7. Furthermore, the file processing apparatus 100 may restore and reproduce file 8 by processing other storages.

(3) Connection of Storage S1

The recording/reproduction control module 31 of the file processing apparatus 100 reads the first file image from the storage S1. The file processing module 32 acquires file header 1 from the first file image, analyzes file header 1, and determines that files 1 and 2 are non-divided files which are stored without being divided. Thus, the file processing module 32 can restore and reproduce files 1 and 2 from the first file image.

The file processing module 32 analyzes file header 1 and detects that file 3 is divided into two files, file 8 is divided into four files, and the storage S1 stores file 3_1 (first file of file 3) and file 8_1 (first file of file 8).

As described above, when the file processing apparatus 100 processes the storages S4, S3, and S1, it can restore and reproduce files 1, 2, 5, 6, and 7. Furthermore, the file processing apparatus 100 may restore and reproduce files 3 and 8 by processing other storages.

(4) Connection of Storage S5

The recording/reproduction control module 31 of the file processing apparatus 100 reads the fifth file image from the storage S5. The file processing module 32 acquires file header 5 from the fifth file image, analyzes file header 5, and determines that parity data is stored. Thus, the file processing module 32 analyzes file header 5, detects that the storages S1 to S5 form one storage set, and determines that data of non-processed storage S2 can be restored using the parity data since the data of the storages S1, S3, S4, and S5 have already been acquired.

The file processing module 32 can restore files 4, 3_2, and 8_2 stored in the storage S2 based on the data acquired from the storages S1, S3, and S4 and the parity data acquired from the storage S5, and can reproduce file 4. Also, the file processing module 32 can restore and reproduce file 3 from already restored file 3_1 and currently restored file 3_2. Furthermore, the file processing module 32 can restore and reproduce file 8 from already restored files 8_1, 8_3, and 8_4, and currently restored file 8_2.

With the above processes, the file processing apparatus 100 can restore and reproduce all of files 1 to 8.

As described above, if the storage S5 which stores the parity data is available, the parity data stored in the storage S5 can be acquired, and data stored in, three out of the storages S1 to S4 can be acquired, data stored in the remaining one the storage can be restored and reproduced. That is, when data can be acquired from the storages, the number of which is smaller by one than the number of all the storages, data of all the storages can be restored and reproduced.

Even when the storage S5 which stores the parity data is not available, if data can be acquired from the storages S1 to S4 in random order, data stored in the storages S1 to S4 can be restored and reproduced.

Even when data can be acquired from only some storages, data can be restored and reproduced as much as possible, as described above.

That is, even when data of some storages cannot be acquired, the file processing apparatus 100 or reproduction apparatus 100′ can restore and reproduce files as much as possible from one or a plurality of available storages. For example, when storages are dispersed discretely due to, for example, a disaster, and the configuration of all storages is not available, files can be restored and reproduced as much as possible from one or a plurality of available storages. In addition, the processing order of one or a plurality of available storages is not limited, resulting in convenience.

The second embodiment will be summarized below.

(1) As described in the first embodiment, the file processing apparatus 100 generates a plurality of file formats appended with header data (management information), and records these plurality of file formats on a plurality of storages. Thus, the file processing apparatus 100 or reproduction apparatus 100′ can restore and reproduce files as much as possible from some storages (one or two or more storages) by acquiring the header data from at least one storage even when not all of the plurality of storages are available.

For example, the file processing apparatus 100 can read a file header (management information) from at least one of two out of five storages, can read first and second divided files, which are respectively divisionally recorded in the two storages, based on the file header, can restore an original file or files from the first and second divided files, and can reproduce the original file or files.

Also, the file processing apparatus 100 can read a file header (management information) from at least one of three out of five storages, can read first, second, and third divided files, which are respectively divisionally recorded in the three storages, based on the file header, can restore an original file or files from the first, second, and third divided files, and can reproduce the original file or files.

In addition, the file storage apparatus 100 can read a file header (management information) from at least one of four out of five storages, can read first, second, third, and fourth divided files, which are respectively divisionally recorded in the four storages, based on the file header, can restore an original file or files from the first, second, third, and fourth divided files, and can reproduce the original file or files.

Furthermore, the arrangement of the second embodiment will be summarized below.

(1) The file processing apparatus includes a reading unit configured to read data from a processing target storage medium, and a reproduction unit configured to reproduce, based on read management information, a non-divided file, which is not divisionally recorded on another storage medium, of a plurality of files recorded on the processing target storage medium.

(2) The reading unit of the file processing apparatus reads data from first and second processing target storage media, and the reproduction unit reproduces a non-divided file, which is not divisionally recorded on another storage medium, of a plurality of files recorded on the first processing target storage medium, reproduces a non-divided file, which is not divisionally recorded on another storage medium, of a plurality of files recorded on the second processing target storage medium, and reproduces two divided files, which are divisionally recorded on the first and second processing target storage media, based on the management information read from at least one of the first and second processing target storage media.

(3) The reproduction unit of the file processing apparatus restores, based on the management information, an original file from one of the divided files read from the first processing target storage medium and the other of the divided files read from the second processing target storage medium, and reproduces the original file.

(4) The reading unit of the file processing apparatus parallelly reads data from the first and second processing target storage media.

(5) The reading unit reads data from first, second, third, and fourth processing target storage media of five processing target storage media, and the reproduction unit restores, based on the management information read from at least one of the first, second, third, and fourth processing target storage media which respectively record first, second, third, and fourth divided files generated by dividing an original file into four files, the original file from the first, second, third, and fourth divided files read from the first, second, third, and fourth processing target storage media, and reproduces the original file.

(6) The reading unit reads data from first, second, and third processing target storage media of five processing target storage media, and the reproduction unit restores, based on the management information read from at least one of the first, second, and third processing target storage media which respectively record first, second, and third divided files generated by dividing an original file into three files, the original file from the first, second, and third divided files read from the first, second, and third processing target storage media, and reproduces the original file.

(7) A file processing method includes: reading data from a processing target storage medium; and reproducing, based on the read management information, a non-divided file, which is not divisionally recorded on another storage medium, of a plurality of files recorded on the processing target storage medium.

According to at least one embodiment, a file processing apparatus and file processing method, which can reduce losses of a recording capacity while reducing a risk of losing files, can be provided.

The various modules of the embodiments described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A file processing apparatus comprising:
a detector configured to detect sizes of processing target files;
a file group generator configured to generate a file group formed by a plurality of first processing target files each having a size less than a threshold size of the processing target files;
a divided file generator configured to generate a plurality of first divided files by dividing the file group, and to generate a plurality of second divided files by dividing a second processing target file having a size not less than the threshold size of the processing target files; and
a recorder configured to record a plurality of combined files each obtained by combining one first divided file and one second divided file on a plurality of recording destinations.

2. The apparatus of claim 1, wherein the divided file generator is configured to divide the file group into the predetermined number of files to generate the predetermined number of first divided files, and to divide the second processing target file into the predetermined number of files to generate the predetermined number of second divided files.

3. The apparatus of claim 2, wherein the divided file generator is configured to divide the file group into files as many as the number of recording destinations, and to divide the second processing target file into files as many as the number of recording destinations.

4. The apparatus of claim 3, wherein the divided file generator is configured to divide the file group into files each having a first size, and to divide the second processing target file into files each having a second size.

5. The apparatus of claim 1, wherein the recorder is configured to record, on the respective recording destinations, management information indicating that the plurality of combined files are respectively recorded on the plurality of recording destinations.

6. The apparatus of claim 5, wherein the recorder is configured to record the management information including information indicating recording destinations of the plurality of first divided files on the respective recording destinations.

7. The apparatus of claim 6, wherein the recorder is configured to record the management information including information indicating recording destinations of the plurality of second divided files on the respective recording destinations.

8. The apparatus of claim 1, wherein the recorder is configured to parallelly record the plurality of combined files on the plurality of recording destinations, respectively.

9. The apparatus of claim 1, wherein the recorder is configured to record error detection data for the plurality of combined files recorded on the plurality of recording destinations on a recording destination different from the plurality of recording destinations.

10. A file processing method comprising:
detecting sizes of processing target files;
generating a file group formed by a plurality of first processing target files each having a size less than a threshold size of the processing target files;
generating a plurality of first divided files by dividing the file group, and generating a plurality of second divided files by dividing a second processing target file having a size not less than the threshold size of the processing target files; and
recording a plurality of combined files each obtained by combining one first divided file and one second divided file on a plurality of recording destinations.
